(19) United States
(12) Patent Application Publication
(10) Pub. No.: US 2026/0044565 A1
(43) Pub. Date: Feb. 12, 2026

(54) GEOSPATIAL DATA PLATFORM, GEOSPATIAL DATA USING SYSTEM, GEOSPATIAL DATA PROVIDING METHOD, AND PROGRAM

(71) Applicant: Hitachi, Ltd., Tokyo (JP)

(72) Inventors: Pablo MARTINEZ LERIN, Tokyo (JP); Tsutomu KUSABA, Tokyo (JP)

(73) Assignee: Hitachi, Ltd., Tokyo (JP)

(21) Appl. No.: 19/214,128

(22) Filed: May 21, 2025

(30) Foreign Application Priority Data
Aug. 9, 2024 (JP) 2024-134705

(51) Int. Cl. G06F 16/903; G06F 16/909

(52) U.S. Cl. CPC G06F 16/90335; G06F 16/909

(57) ABSTRACT

A geospatial data platform is a system that acquires geospatial data corresponding to an acquisition condition registered in advance and provides the acquired geospatial data to the application. The acquisition condition includes region conditions related to a geographical range of the geospatial data in future and time conditions related to an acquisition timing of the geospatial data. For each acquisition timing designated by the time conditions, the geospatial data satisfying the region conditions at the acquisition timing is prepared before a request is made from the application.

### BACKGROUND OF THE INVENTION

### 1. Field of the Invention

The present invention relates to a platform and a method for achieving a service using geospatial data.

### 2. Description of Related Art

In the related art, various services using geospatial data including information indicating a specific place on earth and various pieces of information associated with the information are known. In a service using such geospatial data, for example, a technique disclosed in Patent Literature 1 is known. Patent Literature 1 describes a computer system as a geospatial data platform that is provided between a client browser providing a user interface and a database holding geospatial data, acquires the geospatial data from the database in response to a request of a user and processes the geospatial data, and provides the geospatial data to the user via the client browser. By using the geospatial data platform as disclosed in Patent Literature 1, various services based on the geospatial data can be easily and efficiently provided to the user.

### Citation List

### Patent Literature

Patent Literature 1: U.S. Pat. No. 11,360,970

### SUMMARY OF THE INVENTION

In the computer system described in Patent Literature 1, depending on a content of a service to provided, it is necessary to take a significant amount of time to acquire geospatial data required for that service from the database and process the geospatial data, resulting in extremely long response times for the service. Faster response times are desirable for applications that derive routine insights from large amounts of geospatial data and provide the routine insights to a user, such as applications for commodity trading, various risk predictions, and disaster response.

As a method for meeting the demand as described above, it is conceivable to download necessary geospatial data to a computer system in advance and process the data, but in order to accurately cope with various services provided to users, a very large amount of storage and computational resources are required. Further, the geospatial data held by the database may be frequently changed at any unexpected timing, for example, when a new customer asset is registered, when a part of a land is reused, or when an unexpected disaster occurs. Therefore, there is room for improvement in terms of storage and computational resources and/or in terms of data updates by simply applying general technology such as data cache.

The invention has been made in view of such a background, and an object of the invention is to provide a technique capable of shortening a response time in a service using geospatial data.

A geospatial data platform according to an invention is a system that includes one or more processors and one or more communication interfaces, acquires geospatial data corresponding to an acquisition condition registered in advance, and provides the acquired geospatial data to an application via the one or more communication interfaces, in which
the acquisition condition includes a region condition related to a geographical range of the geospatial data in the future and a time condition related to an acquisition timing of the geospatial data, and
the one or more processors prepare, for each acquisition timing designated by the time condition, the geospatial data satisfying the region condition at the acquisition timing before a request is made from the application.

A geospatial data using system according to an invention includes:
the geospatial data platform; and
one or more computers configured to perform processing of at least one of a geospatial data provider, the application, a geocoding service, an LULC data set, a news distribution service, and a customer database.

A geospatial data providing method for acquiring geospatial data corresponding to an acquisition condition registered in advance and providing the geospatial data to an application,
the acquisition condition including a region condition related to a geographical range of the geospatial data in the future and a time condition related to an acquisition timing of the geospatial data,
the method includes:
   a computer preparing, for each acquisition timing designated by the time condition, the geospatial data satisfying the region condition at the acquisition timing before a request is made from the application; and
   providing the prepared geospatial data from the computer to the application in response to the request from the application.

A program according to an invention causes the computer to execute the geospatial data providing method.

According to the invention, it is possible to provide a technique capable of shortening a response time in a service using geospatial data.

### BRIEF DESCRIPTION OF THE DRAWINGS

FIG. 1 is a diagram illustrating a schematic configuration of a geospatial data using system including a geospatial data platform according to an embodiment of the invention;

FIG. 2 is a diagram illustrating a functional configuration of the geospatial data platform according to the embodiment of the invention;

FIG. 3 shows an example of geospatial data;

FIG. 4 is a diagram illustrating an example of geocoding service data of a geocoding service;

FIG. 5 is a diagram illustrating an example of LULC data in an LULC data set;

FIG. 6 is a diagram illustrating an example of news distribution data of a news distribution service;

FIG. 7 is a diagram illustrating an example of customer data of a customer database;

FIG. 8 is a diagram illustrating an example of a dynamic area table;

FIG. 9 is a diagram illustrating an example of a registered scope table;

FIG. 10 is a flowchart illustrating a processing procedure for a scope registration program;

FIG. 11 is a flowchart illustrating a processing procedure for a data update program;

FIG. 12 is a flowchart illustrating a processing procedure for a data download program;

FIG. 13 is a flowchart illustrating a processing procedure for a data request program;

FIG. 14 is a flowchart illustrating a processing procedure for a dynamic area calculation process;

FIG. 15 is a flowchart illustrating a processing procedure for a dynamic area calculation process for LULC;

FIG. 16 is a flowchart illustrating a processing procedure for a dynamic area calculation process for customer data; and

FIG. 17 is a flowchart illustrating a processing procedure for a dynamic area calculation process for a news distribution.

### DESCRIPTION OF EMBODIMENTS

Hereinafter, embodiments of the invention will be described with reference to the drawings.

The invention discloses a technique for achieving a data platform in which a future request range for geospatial data is registered in advance, and geospatial data corresponding to a registered content and various external information sources such as a land use map, a news distribution, and a customer database is acquired and provided to various applications. By using the geospatial data platform according to the invention, it is possible to achieve a system capable of periodically preparing geospatial data necessary for an application in advance and quickly responding to a request of the application.

The geospatial data handled by the geospatial data platform according the invention may be various types of data associated with both a time and a place. The geospatial data includes, for example, data measured from satellites, weather reports, weather forecasts, data measured from drones, data measured from airplanes, and various IoT data.

An application that receives the geospatial data from the geospatial data platform according the invention analyzes the provided geospatial data for use cases such as risk prevention, damage assessment, optimized agriculture, operation support, and emergency response. Accordingly, various findings using the geospatial data are provided to users of the application.

Hereinafter, an embodiment of the invention will be described. In the present embodiment, an example will be described in which an acquisition range of geospatial data is determined using a land use and land cover (LULC) data set provided from the external information source, a customer database provided from the external information source, or news and a geocoding service provided from the external information source.

In the present embodiment, as a use case in which the LULC data set is used, for example, a case in which weather forecast data as geospatial data necessary for this service is provided to an application that predicts a risk of a forest fire in a forest area using daily weather forecast data will be considered. In this case, as a request from the application, weather data for one week in an area where the LULC data set is regarded as a “forest” is provided every day, which is registered in the geospatial data platform. Accordingly, the geospatial data platform can check the area where the LULC data set is regarded as the “forest” every day, and prepare weather forecast data corresponding to the area as the geospatial data for the application. Further, when the forest area is enlarged or reduced, the geospatial data platform can immediately adjust a provision range of the geospatial data without requiring an interaction with the application.

As a use case in which the customer database is used, for example, the following case is considered. In an organization that provides an asset management service to customers, a customer database used for managing assets held by the customer and an application used by each customer to check analysis information on vegetation near the assets are operated. When a place of any asset held by the customer is input to the application, the application acquires past normalized difference vegetation index (NDVI) data regarding the place, and analyzes vegetation by comparing the NDVI data at two past time points. Further, an obtained analysis result is provided to the customer. In this case, as a request from the application, for example, for a place where the asset of each customer is registered in the customer database, information to be used in a future analysis is NDVI data measurement values from past two months and NDVI data measurement values from past six months, which is registered in the geospatial data platform. Accordingly, the geospatial data platform can prepare NDVI data corresponding to a condition as the geospatial data for the application so that the application can immediately acquire the NDVI data necessary for analyzing the vegetation as necessary. Further, when a new customer is added to the organization, the geospatial data platform can check a place of a new asset in the customer database and prepare NDVI data corresponding to the place as geospatial data for the application.

Further, for example, the following case is considered as a use case in which the news and the geocoding service are used. When the forest fire is reported by the news, the application compares two images before and after the forest fire, and provides the user with insight into the damage assessment. In this case, as a request from the application, for example, for a report of the forest fire that will be distributed in future news, RGB data of a scene of the forest fire that was captured in a week before the news distribution and RGB data of the same scene that was captured in a week after the news distribution are provided, which is registered in the geospatial data platform. Accordingly, the geospatial data platform can periodically search for the report of the forest fire in the distributed news, and when the forest fire occurs, also use the geocoding service to prepare the RGB data of the scene of the forest fire as the geospatial data for the application.

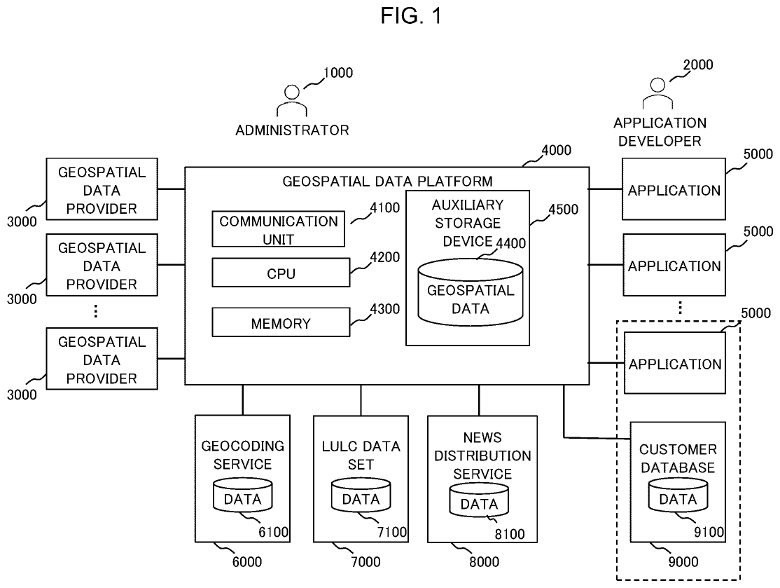

### FIG. 1: System Configuration

FIG. 1 is a diagram illustrating a schematic configuration of a geospatial data using system including the geospatial data platform according to the embodiment of the invention. The geospatial data using system shown in FIG. 1 includes a geospatial data platform 4000 which is a system that includes one or more processors and one or more communication interfaces, acquires geospatial data corresponding to an acquisition condition registered in advance, and provides the acquired geospatial data to the application via the communication interface, one or a plurality of geospatial data providers 3000, one or a plurality of applications 5000, a geocoding service 6000, an LULC data set 7000, a news distribution service 8000, and a customer database 9000 which are connected to the geospatial data platform 4000. In the following description, a hardware configuration of the geospatial data provider 3000 will also be described, but entities other than the geospatial data provider may have the same hardware configuration.

The geospatial data platform 4000 is managed by one or more administrators 1000. The administrator 1000 is a person who manages the geospatial data platform 4000. The administrator 1000 can establish connection between the geospatial data platform 4000 and other system elements (geospatial data providers 3000, applications 5000, geocoding service 6000, LULC data set 7000, news distribution service 8000, and customer database 9000) by appropriately operating the geospatial data platform 4000, which is an information processing device, using an input and output device (not shown) (for example, a mouse, a keyboard, a display, or the like), and can form the geospatial data using system as shown in FIG. 1. Specifically, the administrator 1000 can establish the connection between the geospatial data platform 4000 and the system elements by registering, in the geospatial data platform 4000, connection information such as an Internet address or a digital certificate of each system element.

The administrator 1000 can obtain, for example, connection information with each system element as published connection information. Further, in the case of a system element that belongs to the same organization as the geospatial data platform 4000 and is connected to the same network in the organization, the system element can be accessed in the network without particularly requiring the connection information. Alternatively, in accordance with a contract or partnership, it is also possible to request an organization that operates and manages each system element for the connection information with the system element.

Each application 5000 is developed by one or more application developers 2000. The application developer 2000 is a person who develops the application 5000 that provides various services to a user using the geospatial data provided from the geospatial data platform 4000.

The administrator 1000 and the application developer 2000 may be, for example, a program or artificial intelligence operating on the information processing device instead of a human.

The geospatial data provider 3000 is a service for providing geospatial data corresponding to a request from each application 5000 to a respective application via the geospatial data platform 4000. The geospatial data platform 4000 requests the corresponding geospatial data from each geospatial data provider 3000 according to a request condition of each application registered in advance. The geospatial data provider 3000 prepares the requested geospatial data. This may take several days. When the requested geospatial data is prepared, the geospatial data provider 3000 allows the geospatial data platform 4000 to download the geospatial data. At this time, a predetermined notification may be transmitted from the geospatial data provider 3000 to the geospatial data platform 4000 as necessary.

In the present embodiment, the geospatial data provider 3000 can accept, for example, the following three types of requests from the geospatial data platform 4000, and cause the geospatial data platform 4000 to download the geospatial data corresponding to the request.
(1) Archive: request for geospatial data associated with a certain time point in past
(2) Prediction: request for spatial data associated with a certain time point in future obtained by analyzing tendency of past geospatial data
(3) Task: request for spatial data associated with a certain time point in future determined by schedule

The geospatial data platform 4000 provides the geospatial data downloaded from the geospatial data provider 3000 to each application 5000.

Each application 5000 is a program that provides a predetermined service to the user using the geospatial data provided from the geospatial data platform 4000. In order to receive the geospatial data, each application 5000 transmits, to the geospatial data platform 4000, information for registering in advance the provision range of the geospatial data. This information includes a value that defines a range of the geospatial data that will be received by the application 5000 from the geospatial data platform 4000 at a future time point. The geospatial data platform 4000 transmits the geospatial data corresponding to the provision range registered in advance to each application 5000.

The geocoding service 6000 includes geocoding service data 6100 for associating an address with a physical place. In the geocoding service data 6100, the physical place corresponding to each address can be represented by, for example, center coordinates (latitude and longitude) of each place, a list of vertex coordinates of a polygon forming a boundary line of each place, or the like, but is not limited thereto.

The geospatial data platform 4000 requests information on a place corresponding to a specific address from the geocoding service 6000. This request includes information indicating an address of a certain place. In response to the request from the geospatial data platform 4000, the geocoding service 6000 searches for a place corresponding to a designated address in the geocoding service data 6100 and returns a coordinate value of the place as a response.

The LULC data set 7000 includes LULC data 7100 related to a type of land use in an entire area. For example, the LULC data set 7000 stores, as the LULC data 7100, information indicating a land use status throughout Japan at a resolution of 1×1 kilometer. The LULC data 7100 is periodically updated when the type of land use changes.

The geospatial data platform 4000 requests information on a place corresponding to a condition registered in advance from the LULC data set 7000. This request includes information on the type of land use. In response to the request from the geospatial data platform 4000, the LULC data set 7000 searches for places corresponding to a designated type of land use in the LULC data 7100, and returns a list of places as a response.

The news distribution service 8000 includes news distribution data 8100 related to latest news published by one or more news sources. The news distribution data 8100 is periodically updated. In response to the request from the geospatial data platform 4000, the news distribution service 8000 returns a list of news information represented by the news distribution data 8100.

The customer database 9000 is a database for managing customer asset information. For example, a certain organization holds the customer database 9000 and the application 5000. Such an organization stores information on assets held by customers in the customer database 9000 and provides a service to the customer through the application 5000. The customer database 9000 includes, for example, customer data 9100 in which a type of an asset held by each customer is associated with a physical place where the asset is present. The physical place of the asset can be represented by, for example, center coordinates (latitude and longitude) of the place, a list of coordinates forming a polygon or a polyline indicating a range of the place, but is not limited thereto.

The geospatial data platform 4000 requests information on the place corresponding to the asset held by the customer from the customer database 9000. This request includes information on the type of asset. In response to the request from the geospatial data platform 4000, the customer database 9000 searches for a place of a designated asset in the customer data 9100, and returns information on the place as a response. At this time, a condition may be added as necessary to narrow down assets to be searched.

The geospatial data platform 4000 is achieved by using one or more general information processing devices such as a personal computer (PC) and a server. The geospatial data platform 4000 includes a communication unit 4100, a CPU 4200, a memory 4300, and an auxiliary storage device 4500.

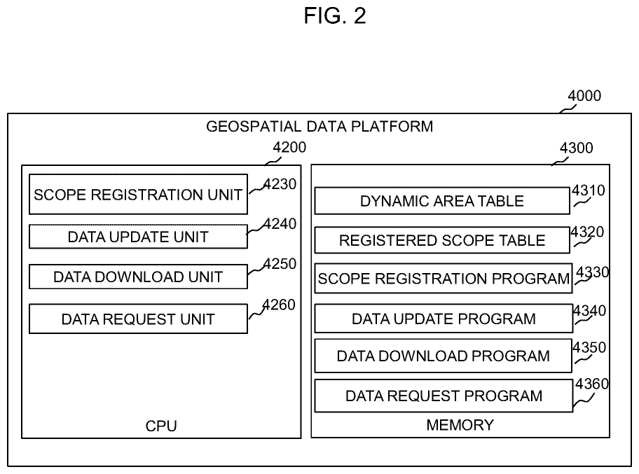

The CPU 4200 controls each unit of the geospatial data platform 4000 and performs calculations related to various processes executed in the geospatial data platform 4000. The CPU 4200 can achieve functional blocks (see FIG. 2 to be described later) in the geospatial data platform 4000 by executing programs stored in the memory 4300. The memory 4300 is a semiconductor storage device such as a random access memory (RAM), and temporarily stores a program loaded from the auxiliary storage device 4500 and executed by the CPU 4200 and necessary work data.

The communication unit 4100 operates under the control of the CPU 4200, and performs interface processing to transmit and receive various types of information between the geospatial data platform 4000 and the other system elements (geospatial data providers 3000, applications 5000, geocoding service 6000, LULC data set 7000, news distribution service 8000, and customer database 9000) via a communication network (not shown) and a communication interface (for example, a network interface card (NIC) or a wired or wireless communication circuit) which is a device that communicates with the communication network.

The auxiliary storage device 4500 is, for example, a large-capacity non-transitory magnetic storage device or semiconductor storage device such as a hard disk drive (HDD) or a solid state drive (SSD), and records the program to be executed by the CPU 4200 and data used by processing of the CPU 4200. The auxiliary storage device 4500 temporarily stores the geospatial data downloaded from the geospatial data provider 3000. In FIG. 1, the geospatial data downloaded from the geospatial data provider 3000 and temporarily stored in the auxiliary storage device 4500 is shown as geospatial data 4400. Details of the geospatial data 4400 will be described later.

### FIG. 2: Functional Configuration of Geospatial Data Platform

FIG. 2 is a diagram illustrating a functional configuration of the geospatial data platform according to the embodiment of the invention. The geospatial data platform 4000 includes functional blocks of a scope registration unit 4230, a data update unit 4240, a data download unit 4250, and a data request unit 4260. These functional blocks are achieved in the geospatial data platform 4000 by reading tables, that is, a dynamic area table 4310 and a registered scope table 4320, and programs, that is, a scope registration program 4330, a data update program 4340, a data download program 4350, and a data request program 4360 from the auxiliary storage device 4500 into the memory 4300, and executing processing of the programs using data stored in each table in the CPU 4200.

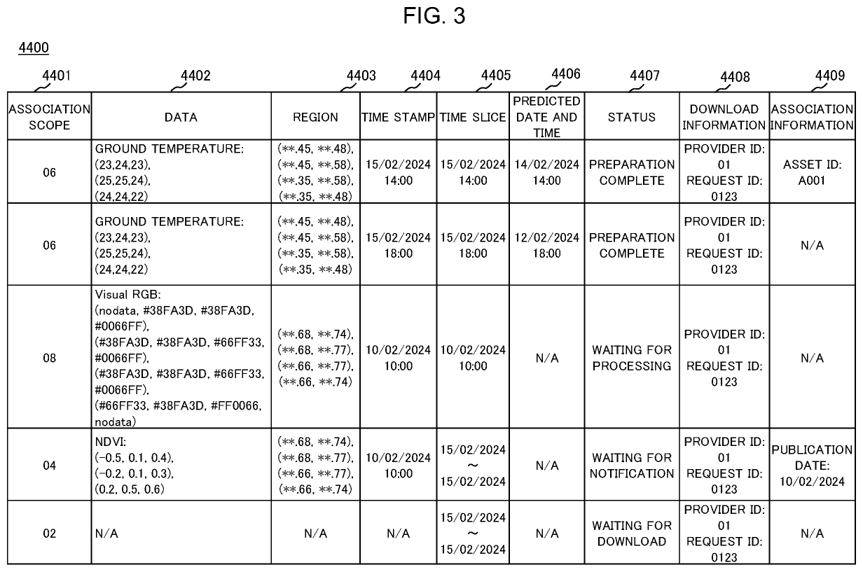

### FIG. 3: Geospatial Data

FIG. 3 is a diagram illustrating an example of the geospatial data 4400 stored in the auxiliary storage device 4500. The geospatial data 4400 has, for example, a plurality of rows set for each data unit provided to each application 5000. In each of the plurality of rows, data corresponding to columns, that is, an association scope 4401, data 4402, a region 4403, a time stamp 4404, a time slice 4405, predicted date and time 4406, a status 4407, download information 4408, and association information 4409, is recorded, whereby the geospatial data 4400 in FIG. 3 is formed.

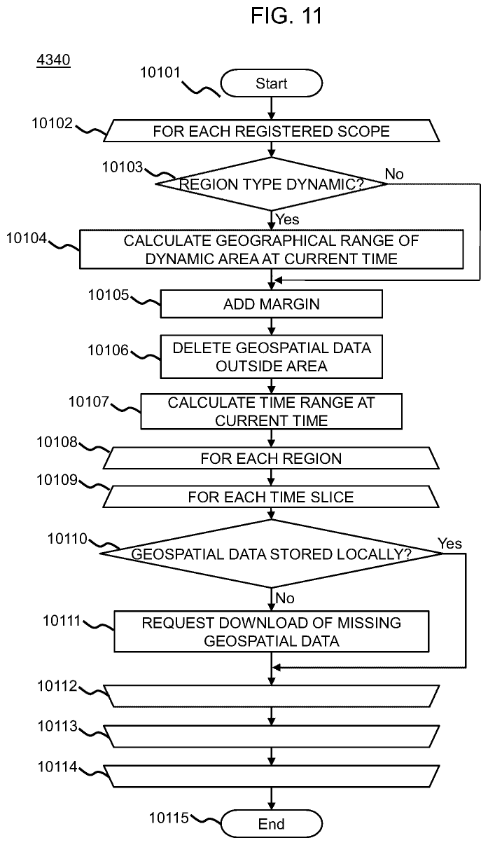

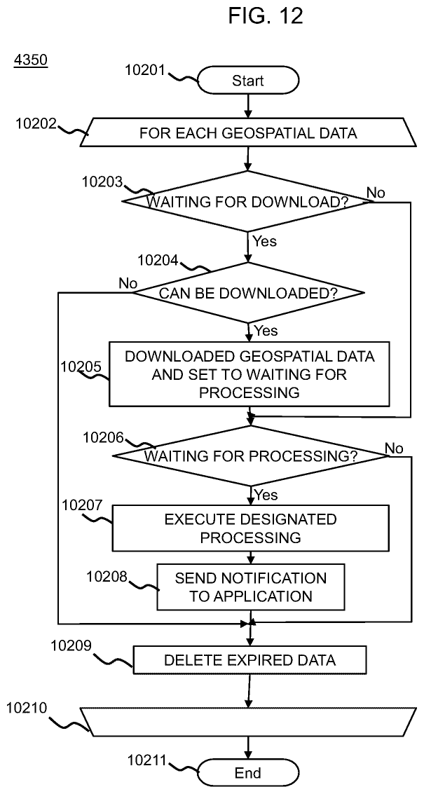

The geospatial data platform 4000 creates and updates the geospatial data 4400 by respectively performing processing shown in FIGS. 11 and 12, which will be described later, in the data update unit 4240 and the data download unit 4250.

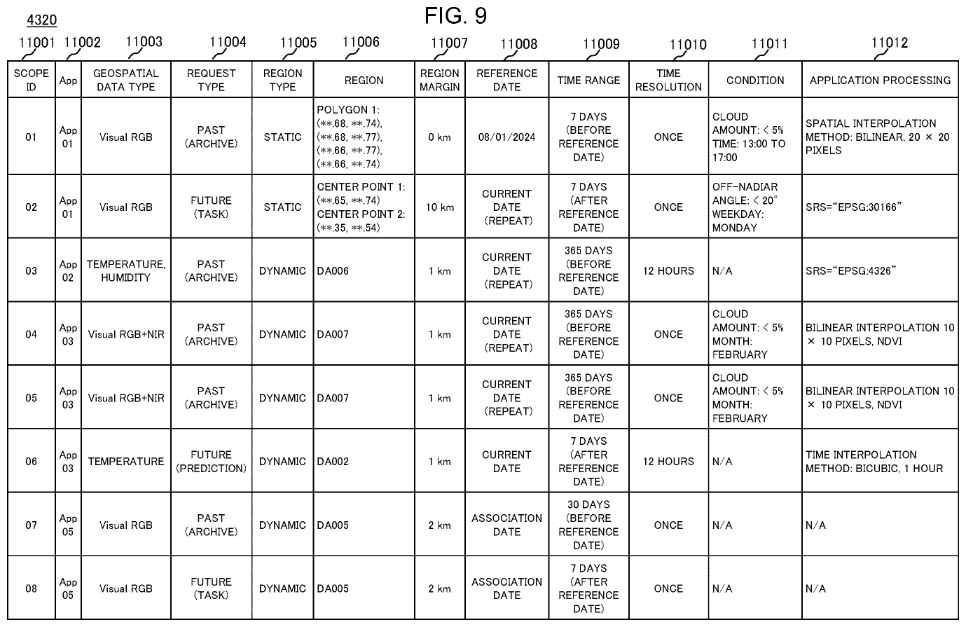

The association scope 4401 indicates an identifier of a registered scope associated with the row of the geospatial data 4400 among registered scopes represented by rows of the registered scope table 4320 illustrated in FIG. 9 to be described later. In the association scope 4401, an ID number common to a scope ID 11001 to be described later in the registered scope table 4320 is stored as the identifier of the associated registered scope.

The data 4402 indicates a content of geospatial data represented by the row. In the example of FIG. 3, the content of the geospatial data is expressed in a simplified manner. In order to more completely express a content of the geospatial data 4400, the data 4402 may include metadata such as a pixel size and a coordinate reference system.

The region 4403 indicates a position and a range of a place represented by the geospatial data of the row. The region 4403 stores, for example, a list of coordinates (latitude and longitude) of each vertex of a polygon forming a boundary line of a region of geospatial data.

The time stamp 4404 indicates a date and a time indicated by the geospatial data of the row. For example, in the case of measured data, the date and the time when the data was measured are stored in the time stamp 4404. In the case of data related to future prediction, a future date and a future time represented by a prediction result of the data are stored in the time stamp 4404.

A time slice 4405 indicates an acquisition interval of the geospatial data of the row. The date and the time indicated by the time stamp 4404 are within a period of the time slice 4405 stored in the same row in the geospatial data 4400.

The predicted date and time 4406 indicates the date and the time when the prediction is calculated for the geospatial data of the row. The predicted date and time 4406 is applied only to the “prediction” among three types of requests made from the geospatial data platform 4000 to the geospatial data provider 3000. Values of the date and the time stored in the predicted date and time 4406 are useful for knowing how much prediction has been executed in the geospatial data provider 3000.

The status 4407 indicates in which stage the geospatial data of the row is in an acquisition process. In the status 4407, for example, keywords, that is, “waiting for download”, “waiting for notification”, “preparation complete”, and “expiration”are stored in the order of stages of the acquisition process.

The download information 4408 indicates information of a download destination of the geospatial data of the row. The download information 4408 stores, for example, an ID number of a request transmitted when the geospatial data platform 4000 requests the geospatial data provider 3000 to download the geospatial data.

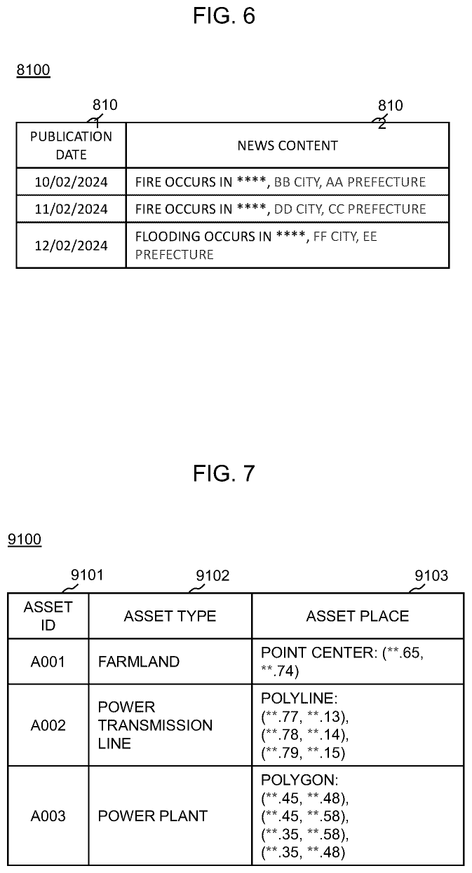

The association information 4409 indicates information associated with a region (dynamic area) when the region corresponding to the geospatial data of the row dynamically changes. Specifically, for example, a value of an asset ID 9101 of data used for a calculation of the dynamic area in the customer data 9100 shown in FIG. 7 to be described later and a value of a publication date 8101 of news used for a calculation of the dynamic area in the news distribution data 8100 shown in FIG. 6 to be described later are stored in the association information 4409. Values of the region 4403 in the same row are calculated using the information indicated in the association information 4409.

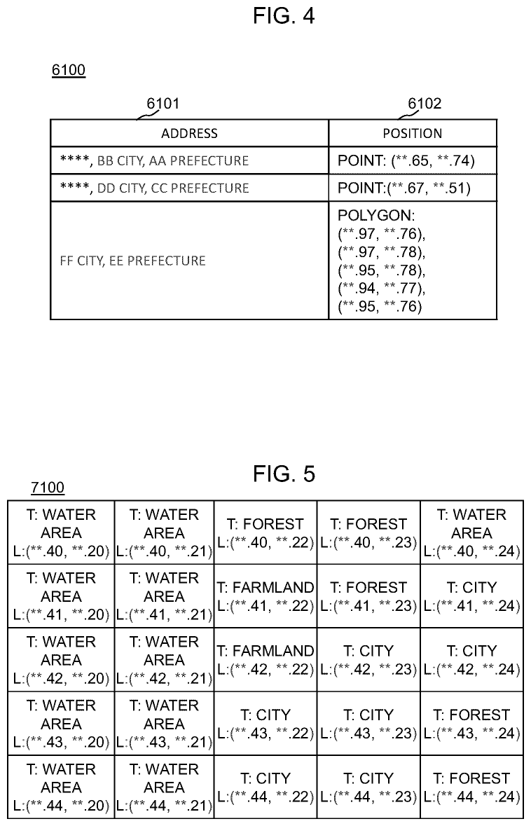

### FIG. 4: Geocoding Service Data

FIG. 4 is a diagram illustrating an example of the geocoding service data 6100 of the geocoding service 6000. The geocoding service data 6100 includes, for example, a plurality of rows set for each place where the geocoding service can be provided. In each of the plurality of rows, data corresponding to columns, that is, an address 6101 and a position 6102, is recorded, whereby the geocoding service data 6100 in FIG. 4 is formed.

The address 6101 indicates a text of an address notation representing a place of the row. The address notation may represent an address assigned to a particular building or place, or may represent an address range for a larger region, such as a particular district or city.

The position 6102 indicates coordinate values representing a position of the place of the row. Here, coordinate values (latitude and longitude) of a point corresponding to the place of the row and a list of coordinate values of each of vertices of a polygon representing a range of a physical region corresponding to the place of the row is stored.

### FIG. 5: LULC Data

FIG. 5 is a diagram illustrating an example of the LULC data 7100 in the LULC data set 7000. The LULC data 7100 is, for example, data representing a digital map of a physical region in any area, and includes raster data in which a plurality of cells are combined. The number of rows and columns of the LULC data 7100 is set according to a size of the physical region represented by the LULC data 7100, a pixel size and a resolution of the digital map represented by the LULC data 7100, and the like. The LULC data 7100 is periodically updated according to a change in a type of land use of each cell.

Each cell of the LULC data 7100 represents respective pixel of the digital map, and includes attribute information T representing a geographical feature of the cell and coordinate information L representing a position of the cell.

The coordinate information L indicates coordinates (latitude and longitude) of a pixel position on the digital map of the cell.

The attribute information T indicates an LULC value of the cell. The LULC value is a value obtained by classifying the type of land use in a specific time or a time range, and is, for example, any one of “water area”, “city”, “farmland”, “forest”, and “wasteland”, but is not limited thereto.

### FIG. 6: News Distribution Data

FIG. 6 is a diagram illustrating an example of the news distribution data 8100 in the news distribution service 8000. The news distribution data 8100 includes, for example, a plurality of rows set for each published news item. In each of the plurality of rows, data corresponding to columns, that is, a publication date 8101 and a news content 8102, is recorded, whereby the news distribution data 8100 in FIG. 6 is formed. The news distribution data 8100 is periodically updated in response to a disclosure of new news.

The publication date 8101 indicates a date when news in the row is published.

The news content 8102 indicates a text representing a content of the news in the row.

### FIG. 7: Customer Data

FIG. 7 is a diagram illustrating an example of the customer data 9100 in the customer database 9000. The customer data 9100 includes, for example, a plurality of rows set for each customer asset managed by the customer database 9000. In each of the plurality of rows, data corresponding to columns, that is, an asset ID 9101, an asset type 9102, and an asset place 9103, is recorded, whereby the customer data 9100 in FIG. 7 is formed. The customer data 9100 is periodically updated as changes occur to the customer assets managed by the customer database 9000, as old assets are discarded and new assets are added.

The asset ID 9101 indicates an ID number which is an identifier of an asset represented by the row.

The asset type 9102 indicates a keyword corresponding to the type of asset represented by the row.

The asset place 9103 indicates coordinate values of a place where the asset represented by the row is present. Here, coordinate values (latitude and longitude) of a point corresponding to the place where the asset of the row is present and a list of coordinate values of each of vertices of a polygon or a polyline representing a range of a physical place occupied by the asset of the row is stored.

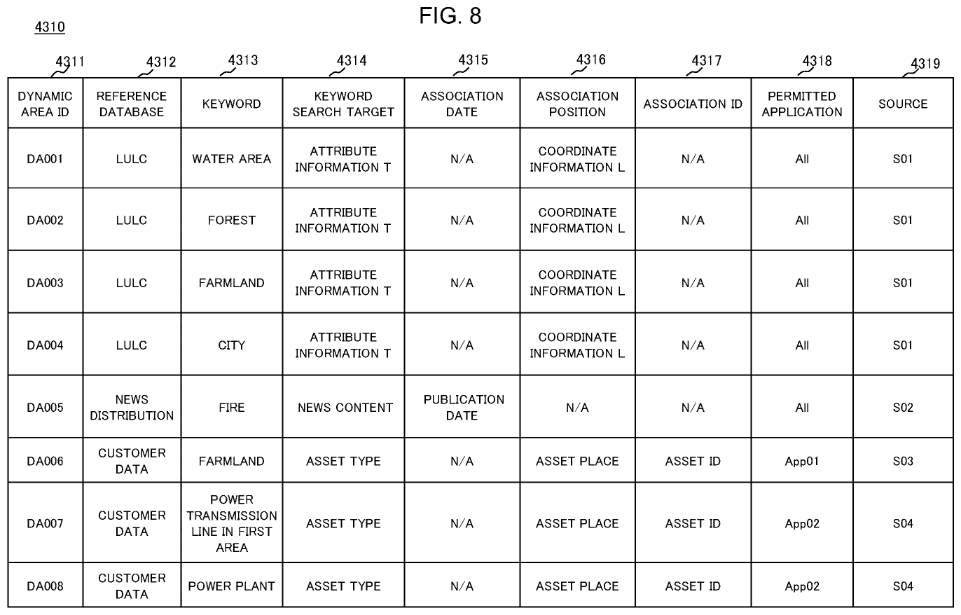

### FIG. 8: Dynamic Area Table

FIG. 8 is a diagram illustrating an example of the dynamic area table 4310. In the geospatial data using system according to the present embodiment, in order to cope with various use cases as described above, in the geospatial data platform 4000, region conditions for determining a dynamic area in which a geographical range dynamically changes over time can be registered as a future request range of geospatial data of each application 5000. The dynamic area table 4310 indicates the region conditions for determining the geographical range of each dynamic area in which the geographical range changes dynamically in this manner.

The dynamic area table 4310 includes, for example, a plurality of rows set for each region condition registered in advance. In each of the plurality of rows, data corresponding to columns, that is, a dynamic area ID 4311, a reference database 4312, a keyword 4313, a keyword search target 4314, an association date 4315, an association position 4316, an association ID 4317, a permitted application 4318, and a source 4319, is recorded, whereby the dynamic area table 4310 in FIG. 8 is formed.

The dynamic area table 4310 is updated in the geospatial data platform 4000 according to a state of connection to the LULC data set 7000, the news distribution service 8000 or the customer database 9000 when the connection is established or deleted. For example, when the LULC data set 7000 is newly connected to the geospatial data platform 4000, the dynamic area table 4310 is updated by inserting a new row according to a type of land described in the LULC data 7100 in the LULC data set 7000. At this time, the dynamic area table 4310 is updated by, for example, the administrator 1000.

The dynamic area ID 4311 indicates an ID number that functions as an identifier of the dynamic area defined by the region conditions represented by the row.

The reference database 4312 indicates a type of database to be referred to when the range of the dynamic area is determined according to the region conditions of the row. In order to determine the range of the dynamic area, for example, each database type such as “LULC” when referring to the LULC data set 7000, “news distribution” when referring to the news distribution service 8000, “customer data” when referring to the “customer database” 9000 is stored in the reference database 4312.

The keyword 4313 indicates a word used as a keyword in searching in each database. The keyword search target 4314 indicates a place of data to be a target of a keyword search in each database. For example, when the reference database 4312 is “LULC” and the range of the dynamic area is determined by referring to the LULC data set 7000, a value indicating the attribute information T of the LULC data 7100 shown in FIG. 5 is stored in the keyword search target 4314. Further, when the reference database 4312 is the “news distribution” and the range of the dynamic area is determined by referring to the news distribution service 8000, a value indicating the news content 8102 of the news distribution data 8100 shown in FIG. 6 is stored in the keyword search target 4314. Further, when the reference database 4312 is the “customer data” and the range of the dynamic area is determined by referring to the customer database 9000, a value indicating the asset type 9102 of the customer data 9100 shown in FIG. 7 is stored in the keyword search target 4314. In addition, a value indicating any data storage place in each database can be stored in the keyword search target 4314.

The association date 4315 indicates a pointer to data indicating a date associated with the keyword when the keyword indicated by the keyword 4313 is searched for in the data storage place indicated by the keyword search target 4314. For example, when the keyword is searched for in the news content 8102 of the news distribution data 8100 shown in FIG. 6, a value indicating the publication date 8101 in the same row is stored in the association date 4315 as the pointer to the data indicating the date related to the keyword. When there is no corresponding data, “N/A” indicating that the data is empty is stored in the association date 4315.

The association position 4316 indicates a pointer to data indicating a position associated with the keyword when the keyword indicated by the keyword 4313 is searched for in the data storage place indicated by the keyword search target 4314. For example, when a keyword is searched for in the attribute information T of the LULC data 7100 shown in FIG. 5, a value indicating coordinate information L of the same cell is stored in the association position 4316 as the pointer to the data indicating the position related to the keyword. Further, when the keyword is searched for in the asset type 9102 of the customer data 9100 shown in FIG. 7, a value indicating the asset place 9103 in the same row is stored in the association position 4316 as the pointer to the data indicating the position related to the keyword. When there is no corresponding data, “N/A”indicating that the data is empty is stored in the association position 4316.

The association ID 4317 indicates a pointer to data indicating an ID associated with the keyword when the keyword indicated by the keyword 4313 is searched for in the data storage place indicated by the keyword search target 4314. For example, when the keyword is searched for in the asset type 9102 of the customer data 9100 shown in FIG. 7, a value indicating the asset ID 9101 in the same row is stored in the association ID 4317 as the pointer to the data indicating the ID related to the keyword. When there is no corresponding data, “N/A”indicating that the data is empty is stored in the association ID 4317.

The permitted application 4318 indicates an application that is permitted to use the region conditions represented by the row when each application 5000 registers a future request range of the geospatial data in the geospatial data platform 4000. For example, in a case in which the customer database 9000 is referred to, by storing a value indicating a related application in the permitted application 4318, it is possible to prohibit access by any application other than the application, thereby preventing unrelated applications from gaining unauthorized access to confidential asset information. Further, the permitted application 4318 can also be used when applications that can use the region conditions are restricted according to a difference in a contract condition.

The source 4319 indicates a database to be referenced when the range of the dynamic area corresponding to the region conditions represented by the row is determined, or an ID number corresponding to an identifier of a service to be used in combination at that time. For example, the ID number for identifying the geocoding service 6000, the LULC data set 7000, the news distribution service 8000, or the customer database 9000 connected to the geospatial data platform 4000 is stored in the source 4319.

### FIG. 9: Registered Scope Table

FIG. 9 is a diagram illustrating an example of the registered scope table 4320. In the geospatial data using system according to the present embodiment, in order to cope with various use cases as described above, a scope representing a condition (type, place, time, and the like) of future geospatial data to be provided to each application 5000 is registered in the geospatial data platform 4000. The registered scope table 4320 represents a scope of the future geospatial data registered in response to a request from each application 5000.

The registered scope table 4320 includes, for example, a plurality of rows set for each scope of previously registered geospatial data. In each of the plurality of rows, data corresponding to columns, that is, a scope ID 11001, an application (App) 11002, a geospatial data type 11003, a request type 11004, a region type 11005, a region 11006, a region margin 11007, a reference date 11008, a time range 11009, a time resolution 11010, a condition 11011, and application processing 11012, is recorded, whereby the registered scope table 4320 in FIG. 9 is formed.

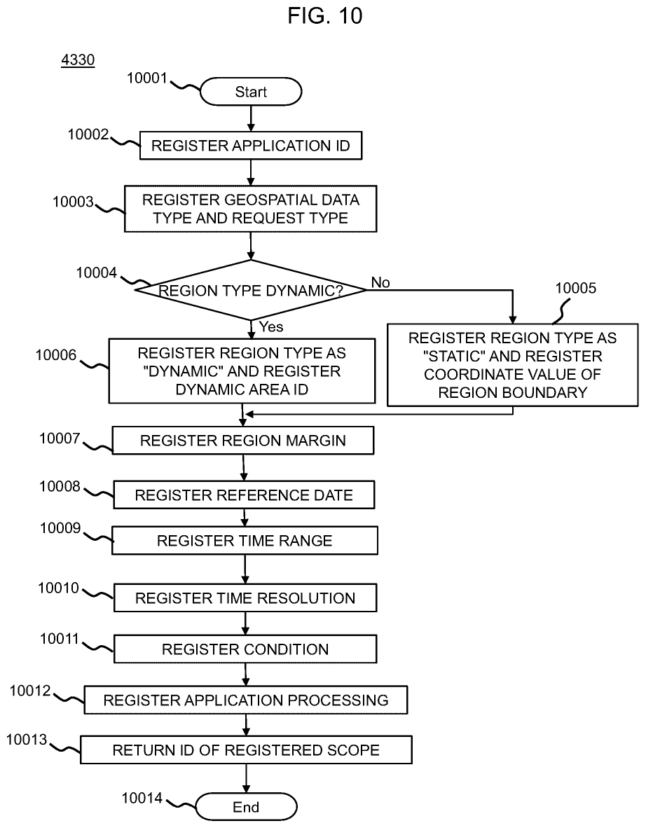

The geospatial data platform 4000 creates and updates the registered scope table 4320 by performing processing illustrated in FIG. 10, which will be described later, in the scope registration unit 4230.

The scope ID 11001 indicates an identifier of a scope in the row. Here, the ID number common to the association scope 4401 of the geospatial data 4400 shown in FIG. 3 described above is stored, whereby the geospatial data 4400 and the registered scope table 4320 are associated with each other.

The app 11002 indicates an ID number representing an identifier of the application 5000 corresponding to the scope in the row. The ID number stored in the app 11002 indicates from which application each scope indicated in the registered scope table 4320 is requested.

The geospatial data type 11003 indicates a type of the geospatial data handled by the application 5000. For example, types of the geospatial data supported by the geospatial data provider 3000 and registered in the geospatial data platform 4000 are stored in the geospatial data type 11003 for each scope. Accordingly, the administrator 1000 can define the type of geospatial data for each scope. An ID number of the geospatial data provider 3000 may be stored in the geospatial data type 11003 as information indicating the type of geospatial data. The ID number of the geospatial data provider 3000 may be provided from the application 5000 at the time of scope registration, for example, or may be set by the administrator 1000. Alternatively, the geospatial data platform 4000 may automatically perform the setting based on criteria such as availability, a cost, and a waiting time.

The request type 11004 indicates a type of a request that the application 5000 makes to the geospatial data provider 3000. Here, a value indicating any one of the above-described three types of requests, that is, “past (archive)”, “future (prediction)”, and “future (task)”is stored.

The “past (archive)” means requesting geospatial data associated with a time in the past, that is, geospatial data from a past measurement result. The “future (prediction)” means requesting a prediction result of future geospatial data calculated by analyzing a tendency in the past geospatial data, that is, geospatial data associated with a certain time point in the future. The “future (task)” means requesting geospatial data associated with a certain time point in the future, that is, geospatial data from a measurement result at a pre-scheduled future time point.

The region type 11005 indicates a type of region for which the application 5000 requests geospatial data from the geospatial data provider 3000. Here, a value indicating either “static” or “dynamic” is stored.

The “static” indicates that a region of geospatial data obtained by the geospatial data platform 4000 in response to a request from the application 5000 will not change at any future time point. That is, a scope in which the region type 11005 is “static” means that geospatial data within the same region is acquired at any time point.

The “dynamic” indicates that a region of geospatial data acquired by the geospatial data platform 4000 in response to a request from the application 5000 may change at any future time point. That is, a scope in which the region type 11005 is “dynamic” means that the application 5000 acquires geospatial data within a region that changes depending on a situation. For example, when the application 5000 uses the geospatial data in response to a request from a customer whose asset information is newly registered in the customer database 9000, it is necessary to acquire geospatial data related to a place where the asset of the customer is present, and thus the “dynamic” is recorded in the region type 11005 in the scope corresponding to the application 5000.

The region 11006 indicates a position and a geographical range of a region for which the application 5000 requests the geospatial data from the geospatial data provider 3000. When the value of the region type 11005 is “static”, the region 11006 stores center coordinates (latitude and longitude) of the region where the geospatial data is requested, a coordinate list of vertices of a polygon indicating a boundary of the region, a coordinate list of a polyline forming a center line of the region, and the like. On the other hand, when the value of the region type 11005 is “dynamic”, a value indicating the dynamic area ID 4311 of the dynamic area table 4310 is stored in the region 11006 as information for determining the position and the geographical range of the region for which the geospatial data is requested.

The region margin 11007 indicates a range of the region for which the application 5000 acquires the geospatial data from the geospatial data provider 3000. For example, when the region 11006 indicates the center coordinates and the application 5000 requires geospatial data for 10 km around the center coordinates, a value of the region margin 11007 is 10 km.

The reference date 11008 indicates a date that the application 5000 refers to when the geospatial data is acquired from the geospatial data provider 3000. Here, a specific date in the future may be stored, or a value indicating either a “current date” or an “association date” may be stored. When the reference date 11008 is the “current date”, the date on which the data update unit 4240 actually updates the geospatial data is set as a date to be referred to when the geospatial data is acquired. Further, when the reference date 11008 is the “association date”, a date specified by a value of the association date 4315 written in the row of the dynamic area table 4310 associated by the value of the dynamic area ID 4311 stored in the region 11006 of the same row is set as a date to be referred to when the geospatial data is acquired. Only when the region type 11005 is “dynamic” and a pointer to any data is set in the association date 4315 in a region condition specified by the value of the dynamic area ID 4311 stored in the region 11006, the “association date” is set in the reference date 11008.

The time range 11009 indicates a period in which the application 5000 acquires the geospatial data from the geospatial data provider 3000. Here, the number of days based on the reference date 11008 of the same row and a value indicating whether the period is before or after the reference date 11008 are stored. For example, when the time range 11009 is “7 days (before the reference date)”, the application 5000 uses a date designated in the reference date 11008 as a reference and requests the geospatial data provider 3000 via the geospatial data platform 4000 for geospatial data in a period from 7 days before the reference date to the reference date.

The time resolution 11010 indicates a frequency at which the application 5000 acquires the geospatial data from the geospatial data provider 3000. For example, when a value stored in the time resolution 11010 is “12 hours”, this means that the application 5000 acquires data measured every 12 hours within a period defined by the reference date 11008 and the time range 11009. Further, when the value stored in the time resolution 11010 is “once”, this means that the application 5000 acquires data that has been measured once at any time point within the period defined by the reference date 11008 and the time range 11009.

The condition 11011 indicates a list of conditions for further filtering geospatial data that may be requested by application 5000 in the future. The condition 11011 can include, for example, a measurement weekday of the geospatial data and a maximum value of a cloud amount as a measurement condition, but is not limited thereto. The condition 11011 is optional, and any value can be set as a default value.

The application processing 11012 indicates a content of processing applied to the geospatial data by the geospatial data platform 4000 before the geospatial data acquired from the geospatial data provider 3000 is provided to the application 5000. For example, when a value stored in the application processing 11012 is “bilinear interpolation 10×10 pixels, NDVI”, this indicates that it is necessary to calculate an NDVI value from the geospatial data acquired from the geospatial data provider 3000 and provide a calculation result included in the geospatial data to the application 5000. A content of processing that can be set in the application processing 11012 is defined by, for example, the administrator 1000. The application processing 11012 is optional, and any value can be set as a default value.

In the configuration of the registered scope table 4320 described above, the region 11006 stores center coordinates of any region and a list of coordinates representing a boundary line or a center line as information for determining a geographical range of static geospatial data that does not change even at a future time point. Alternatively, any row of the dynamic area table 4310 is represented as a condition of the geographical range of the geospatial data that may dynamically change at a future time point. Further, the region margin 11007 represents a range of margin added to the geographical range indicated by the region 11006. That is, the region 11006 and the region margin 11007 correspond to the region condition regarding the geographical range of the geospatial data 4400 in the future. Further, the reference date 11008, the time range 11009, and the time resolution 11010 represent the reference date, the period, and the frequency, respectively, when the application 5000 acquires the geospatial data from the geospatial data provider 3000. That is, the reference date 11008, the time range 11009, and the time resolution 11010 correspond to a time condition related to an acquisition timing of the geospatial data 4400.

### FIG. 10: Scope Registration Program

FIG. 10 is a flowchart illustrating a processing procedure for the scope registration program 4330. When a scope registration request transmitted from the application 5000 is received, the scope registration unit 4230 executes processing of the scope registration program 4330 in accordance with the processing procedure of FIG. 10. Accordingly, a new scope is registered in the registered scope table 4320, and an ID number of the scope is returned to the application 5000.

Step 10001 indicates a start point of the scope registration program 4330. The scope registration program 4330 is started when the scope registration unit 4230 receives the scope registration request transmitted from the application 5000 to the geospatial data platform 4000. This scope registration request includes values indicating the condition of the future geospatial data that the application 5000 requests from the geospatial data platform 4000, such as values shown in each column of the registered scope table 4320 in FIG. 9. These values are set by, for example, the application developer 2000.

When the scope registration request transmitted from the application 5000 is received, the scope registration program 4330 registers a new scope by respectively inputting the values included in the received scope registration request into new rows of the registered scope table 4320 according to the procedure illustrated in the flowchart of FIG. 10. When the received scope registration request includes an invalid value, the scope registration program 4330 returns an error to the application 5000 that has transmitted the scope registration request and ends the processing.

In step 10002, the application ID is acquired from the scope registration request. If necessary, the application ID may be verified using an authentication mechanism such as a digital certificate or a digital token. Further, a new row is added to the registered scope table 4320, a new ID number is stored in the scope ID 11001 of the row, and the acquired application ID is stored in the app 11002.

In step 10003, the type of geospatial data requested by the application 5000 and the type of the request are acquired from the scope registration request, and these values are stored in the geospatial data type 11003 and the request type 11004, respectively, in the row of the registered scope table 4320 added in step 10002.

In step 10003, whether at least one of the geospatial data providers 3000 registered in the geospatial data platform 4000 provides the geospatial data of the type corresponding to the request of the application 5000 may be verified. Furthermore, if a verification result is negative, an error message may be returned to the application 5000 or a notification may be sent to the administrator 1000.

Prior to the processing of step 10003, a list describing the type of geospatial data that can be provided by the geospatial data provider 3000 and the type of geospatial data request that can be dealt by the geospatial data provider 3000 may be provided from the geospatial data platform 4000 to the application 5000. By referring to this list, the application 5000 can determine a content of the scope registration request within a range that can be dealt by the geospatial data provider 3000.

In step 10004, the type of region (static or dynamic) for which the application 5000 requests the geospatial data is acquired from the scope registration request, and whether the type is “static” or “dynamic” is determined. As a result, when the type of the region is “static”, the processing proceeds to step 10005, and when the type is “dynamic”, the processing proceeds to step 10006.

In step 10005, the value of the region type 11005 in the row of the registered scope table 4320 added in step 10002 is set to “static”, and one or more coordinate values that represent a boundary of the region are obtained from the scope registration request, and the list is stored in the region 11006. After the processing of step 10005 is executed, the process proceeds to step 10007.

In step 10006, the value of the region type 11005 in the row of the registered scope table 4320 added in step 10002 is set to “dynamic”, the dynamic area ID is acquired from the scope registration request, and the value is stored in the region 11006. At this time, in the dynamic area table 4310, a row in which the acquired value of the dynamic area is stored in the dynamic area ID 4311 is specified, and by referring to the permitted application 4318 in the same row, whether the application 5000 that has transmitted the scope registration request is permitted to use the region condition is checked. As a result, if not permitted, an error message is returned to the application 5000, and the processing ends. Information on the dynamic area may be provided from the administrator 1000 to the application developer 2000 as necessary. After the processing of step 10006 is executed, the process proceeds to step 10007.

In step 10007, a size of the region margin is acquired from the scope registration request, and the value is stored in the region margin 11007 of the row of the registered scope table 4320 added in step 10002.

In step 10008, the date to be referred to when the application 5000 acquires the geospatial data from the geospatial data provider 3000 is acquired from the scope registration request, and the value is stored in the reference date 11008 of the row of the registered scope table 4320 added in step 10002. At this time, if the acquired reference date is the “association date”, the type of the region acquired in step 10004 is checked to be “dynamic”, and if the type is not “dynamic”, an error message is returned to the application 5000 and the processing ends. Further, in the row of the dynamic area table 4310 specified in step 10006, a value is checked to be set in the association date 4315, and in a case in which the value is not set, an error message is returned to the application 5000, and the processing ends.

In step 10009, the period during which the application 5000 acquires the geospatial data from the geospatial data provider 3000 is acquired from the scope registration request, and the value is stored in the time range 11009 of the row of the registered scope table 4320 added in step 10002.

In step 10010, the frequency at which the application 5000 acquires the geospatial data from the geospatial data provider 3000 is obtained from the scope registration request, and the value is stored in the time resolution 11010 of the row of the registered scope table 4320 added in step 10002.

In step 10011, a condition for the filtering process performed when the application 5000 acquires the geospatial data from the geospatial data provider 3000 is acquired from the scope registration request, and a value thereof is stored in a condition 11011 of the row of the registered scope table 4320 added in step 10002. At this time, the geospatial data platform 4000 can provide a list of usable conditions to the application 5000 as necessary.

In step 10012, the content of processing to be applied before providing the geospatial data acquired from the geospatial data provider 3000 to the application 5000 is acquired from the scope registration request, and the value is stored in the application processing 11012 in the row of the registered scope table 4320 added in step 10002. At this time, the geospatial data platform 4000 can provide a list of applicable processing to the application 5000 as necessary.

In step 10013, the ID number stored in the scope ID 11001 of the row of the registered scope table 4320 added in step 10002 is returned to the application 5000. Accordingly, the application 5000 is notified that a new scope is registered in the registered scope table 4320.

After the processing of step 10013 is executed, the scope registration program 4330 is terminated. Step 10014 indicates an end point of the scope registration program 4330.

### FIG. 11: Data Update Program

FIG. 11 is a flowchart illustrating a processing procedure of the data update program 4340. The data update unit 4240 executes processing of the data update program 4340 according to the processing procedure of FIG. 11 at each predetermined processing cycle. Accordingly, the geospatial data 4400 can be updated based on a content of the registered scope table 4320.

Step 10101 indicates a start point of the data update program 4340. The data update program 4340 is started periodically, for example, every hour. Alternatively, the data update program 4340 is started in response to an instruction from the administrator 1000. Alternatively, the data update program 4340 is started when the registered scope table 4320 is changed. Alternatively, the data update program 4340 is started when an update notification is received from the LULC data set 7000, the news distribution service 8000, or the customer database 9000.

In step 10102, iterative processing is started for each row of the registered scope table 4320.

In step 10103, the values of the region type 11005 and the region 11006 are read from a currently processed row in the registered scope table 4320. Further, if the value of the read region type 11005 is “static”, the process advances to step 10105 to provide a list of coordinates represented by the value of the read region 11006 to processing of step 10105. On the other hand, if the value of the read region type 11005 is “dynamic”, the process proceeds to step 10104.

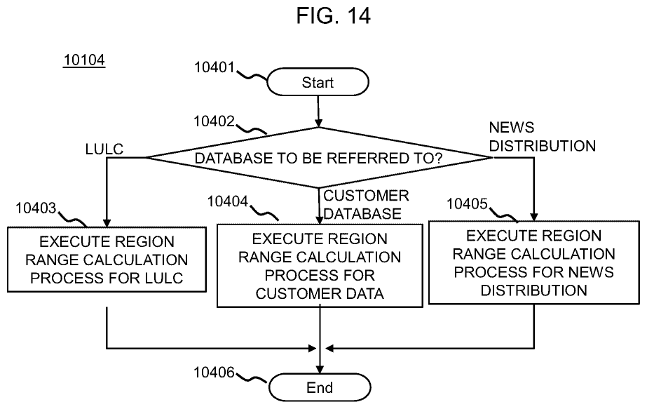

In step 10104, for a dynamic area represented by the currently processed row in the registered scope table 4320, a geographical range of the dynamic area at a current time is calculated. Here, for example, a row in which the same value as the value of the region 11006 read in step 10103 is stored in the dynamic area ID 4311 is specified in the dynamic area table 4310, and the geographical range of the dynamic area at the current time is calculated based on contents of region conditions described in the row. Specifically, by executing a dynamic area calculation process illustrated in the flowchart of FIG. 14 to be described later, it is possible to calculate the geographical range of the dynamic area at the current time for a scope represented by the currently processed row in the registered scope table 4320, and to acquire a list of coordinates corresponding to the geographical range. Details of the flowchart of FIG. 14 will be described later.

In step 10105, a list of the coordinates acquired in step 10103 or step 10104 is received. Further, the value stored in the region margin 11007 is read out from the currently processed row in the registered scope table 4320, and each coordinate value is adjusted based on the value. Accordingly, it is possible to adjust the geographical range of the region specified by the scope represented by the currently processed row.

In step 10106, data outside the area is deleted from the geospatial data 4400 based on each coordinate value adjusted in step 10105. Here, for example, in the geospatial data 4400, a row in which the value of the association scope 4401 matches the scope ID 11001 of the currently processed row in the registered scope table 4320 is found. When the corresponding row is found, the geographical range specified by the value of the region 4403 of the row is compared with the geographical range calculated in step 10105. As a result, when a part of the former geographical range is not included in the latter, data corresponding to the part is deleted from the data 4402 of the same row, and the part is deleted from the value of the region 4403. Further, if the entire geographical range of the former is not included in the latter, the row is deleted from the geospatial data 4400.

In step 10107, a time range corresponding to the current time is calculated. Here, for example, the values stored in the reference date 11008 and the time range 11009 are read from the currently processed row in the registered scope table 4320. When the value of the read reference date 11008 is the “current date”, a current date on which the data update program 4340 is executed is set as a reference date of the time range at the current time. On the other hand, when the value of the read reference date 11008 is the “association date”, an association date included in the region conditions indicated by the row of the dynamic area table 4310 referred to when the geographical range of the dynamic area at the current time is calculated in step 10104 is set as the reference date of the time range at the current time. Further, when the read time range 11009 includes a “previous date”, the time range is calculated by setting a date obtained by subtracting the number of days of the time range 11009 from the set reference date as a start date of the time range and setting the reference date as an end date of the time range. On the other hand, when the read time range 11009 includes a “later date”, the time range is calculated by setting the set reference date as the start date of the time range and setting a date obtained by adding the number of days of the time range 11009 to the reference date as an end date of the time range. Accordingly, the time range corresponding to the current time can be calculated.

In step 10108, iterative processing is started for each region whose geographical range has been calculated in step 10105.

In step 10109, the value of the time resolution 11010 is read from the currently processed row in the registered scope table 4320, and the time range calculated in step 10107 is divided by the read value to calculate a time slice. At this time, when the value of the time resolution 11010 is other than “once”, the number of time slices corresponding to the value is calculated. Further, iterative processing is started for each calculated time slice.

In step 10110, whether the required geospatial data is stored locally in the geospatial data platform 4000 is determined. Here, for example, in the geospatial data 4400, a row is searched for in which the value of the association scope 4401 matches the scope ID 11001 of the currently processed row in the registered scope table 4320, the value of the region 4403 matches a geographical range of a region of the currently processed row in the iterative processing of step 10108, and the value of the time slice 4405 matches a time slice of the currently processed row in the iterative processing of step 10109. If the corresponding row is not found, the geospatial data is determined to be not locally stored, and the process proceeds to step 10111. On the other hand, if the corresponding row is found, the geospatial data is determined to be locally stored, and the process proceeds to step 10112. If necessary, even if the corresponding line is found, a value of the predicted date and time 4406 may be compared with the current date, and if a difference therebetween is greater than a specified number of days, the process proceeds to step 10111 to acquire newer geospatial data from the geospatial data provider 3000.

In step 10111, a request is made to the geospatial data provider 3000 to download missing geospatial data. Here, for example, the currently processed row is read in the registered scope table 4320, and geospatial data corresponding to the geographical range in the region of the currently processed row in the iterative processing of step 10108, the time slice of the currently processed row in the iterative processing of step 10109, and the condition 11011 is requested from the geospatial data provider 3000 specified by the values of the geospatial data type 11003 and the request type 11004 of the row. At this time, when the geospatial data provider 3000 cannot be specified by the geospatial data type 11003 or the request type 11004, an appropriate geospatial data provider 3000 may be selected based on criteria such as availability, a cost, or a waiting time. Further, a new row is added to the geospatial data 4400, the value of the scope ID 11001 described in the currently processed row in the registered scope table 4320 is stored in the association scope 4401, each coordinate value representing the geographical range in the region of the currently processed row in the iterative processing of step 10108 is stored in the region 4403, and date and time representing the time slice of the currently processed row in the iterative processing of step 10109 is stored in the time slice 4405. Further, “waiting for download” is stored in the status 4407, the ID number of the geospatial data provider 3000 specified or selected as the request destination of the geospatial data is stored in the download information 4408, and information associated with the geographical range in the region of the currently processed row in the iterative processing of step 10108 is stored in the association information 4409. An item for which there is no value to be stored may be empty without storing a value. Further, as necessary, a plurality of rows in which values of the association scope 4401 and the region 4403 match may be integrated into one for efficiency.

In step 10111, by performing the processing described above, for each acquisition timing designated by time conditions represented by the reference date 11008, the time range 11009, and the time resolution 11010 in the registered scope table 4320, it is possible to prepare in advance the acquisition of the geospatial data 4400 that satisfies the region conditions at that time point. That is, the geospatial data requested to be downloaded here is downloaded when the data download program 4350 is subsequently executed. Accordingly, when a request is made from the application 5000, the geospatial data platform 4000 can make preparation in advance so that the necessary geospatial data can be instantly provided to the application 5000 in response to the request.

In step 10112, the iterative processing in step 10109 ends. Once the iterative processing has been completed for all time slices, the process proceeds to step 10113.

In step 10113, the iterative processing in step S10108 ends. Once the iterative processing has been completed for all regions, the process proceeds to step S10114.

In step 10114, the iterative processing in step 10102 ends. Once the iterative processing has been completed for all the rows in the registered scope table 4320, the data update program 4340 is terminated. Step 10115 indicates an end point of the data update program 4340.

### FIG. 12: Data Download Program

FIG. 12 is a flowchart illustrating a processing procedure of the data download program 4350. The data download unit 4250 periodically checks whether the corresponding geospatial data can be acquired from the geospatial data provider 3000 for a row in which the status 4407 is “waiting for download” in the geospatial data 4400, and executes processing of the data download program 4350 according to the processing procedure of FIG. 12 when there is acquirable geospatial data. Accordingly, available data is downloaded from the geospatial data provider 3000 to update the content of the geospatial data 4400. Therefore, prior to the request from the application 5000, the geospatial data 4400 prepared in step 10111 of FIG. 11 can be acquired.

Step 10201 indicates a start point of the data download program 4350. The data download program 4350 is started periodically, for example, every hour. Alternatively, the data download program 4350 is started in response to the instruction from the administrator 1000. Alternatively, the data download program 4350 is started when the geospatial data 4400 is changed. Alternatively, the data download program 4350 is started when a new data availability notification is received from the geospatial data provider 3000.

In step 10202, iterative processing is started for each row of the geospatial data 4400.

In step 10203, a value of the status 4407 is read from the currently processed row in the geospatial data 4400. Further, if the value of the read status 4407 is “waiting for download”, the process proceeds to step 10204, and if not, the process proceeds to step 10206.

In step 10204, a provider ID and a request ID stored in the download information 4408 are read from the currently processed row in the geospatial data 4400. Further, the geospatial data provider 3000 corresponding to the read provider ID is inquired as to whether processing of the read request ID has been completed and whether the geospatial data can be downloaded. As a result, if the geospatial data can be downloaded, the process proceeds to step 10205, and if not, the process proceeds to step 10209.

In step 10205, the available geospatial data is downloaded from the geospatial data provider 3000 and stored in the data 4402 in the currently processed row of the geospatial data 4400. Accordingly, the geospatial data requested to be downloaded in step 10111 in the data update program 4340 in FIG. 11 described above can be acquired before the request from the application 5000. Further, the status 4407 in the same row is set to “being processed”. When the downloaded geospatial data is a predicted value, date and time indicated by the predicted value is stored in the predicted date and time 4406 in the same row of the geospatial data 4400.

In step 10206, the value of the status 4407 is read from the currently processed row in the geospatial data 4400. Further, if the value of the read status 4407 is “waiting for processing”, the process proceeds to step 10207, and if not, the process proceeds to step 10209.

In step 10207, processing designated in the registered scope table 4320 is executed on the acquired geospatial data. Here, for example, the value of the association scope 4401 is read from the currently processed row in the geospatial data 4400, and a row in which the same value as the read value is set in the scope ID 11001 is searched for in the registered scope table 4320. Further, a value of the application processing 11012 of the found row is read, and processing represented by the value is applied to the geospatial data stored in the data 4402 in the currently processed row of the geospatial data 4400. When this processing is completed, “waiting for notification” is set in the status 4407. When the value of the application processing 11012 is empty, “waiting for notification” may be set in the status 4407 without applying any particular processing to the geospatial data stored in the data 4402.

In step 10207, by performing the processing described above, the geospatial data to be provided to the application 5000 can be prepared before the request from the application 5000 by using the geospatial data downloaded in step 10205.

In step 10208, a notification that the geospatial data is available is sent to the application 5000. Here, a value of the app 11002 in the row searched in the registered scope table 4320 in step 10207 is read, and the notification is transmitted to the application 5000 represented by the value. When this processing is completed, “preparation complete” is set in the status 4407. Processing of step 10208 is optional and may not be performed.

In step 10209, expired data is deleted from the geospatial data 4400. Here, for example, a value of the time slice 4405 is read from the currently processed row in the geospatial data 4400, and whether the data of the row has expired is determined based on the value. As a result, if the data of the row is determined to be expired, the row is deleted from the geospatial data 4400 for efficiency. Specifically, for example, the read value of the time slice 4405 is compared with the current time, and when a difference is larger than a predetermined threshold value, the data of the row is determined to be expired. The threshold value at this time can be freely set by the administrator 1000, for example. If necessary, the threshold value may be set when the application 5000 transmits the scope registration request. By the processing of step 10209, in the geospatial data 4400, there is a possibility that the data is deemed to have expired and deleted even before the data is provided to the application 5000. As a result, if the data takes too long to become available and is no longer useful to the application 5000, the data can be determined to be unnecessary and deleted, thereby improving efficiency.

In step 10210, the iterative processing in step 10202 ends. Once the iterative processing has been completed for all the rows of the geospatial data 4400, the data download program 4350 is terminated. Step 10211 indicates an end point of the data download program 4350.

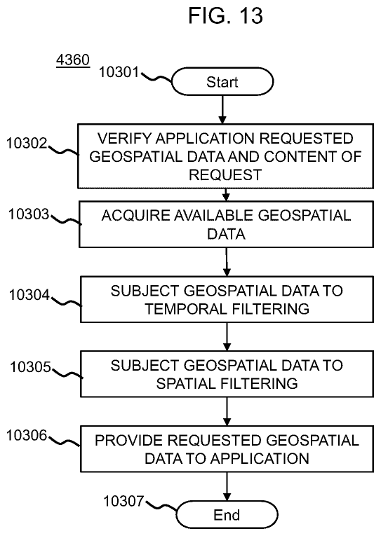

### FIG. 13: Data Request Program

FIG. 13 is a flowchart illustrating a processing procedure of the data request program 4360. When the data request unit 4260 receives the request for the geospatial data from the application 5000, processing of the data request program 4360 is executed in accordance with the processing procedure of FIG. 13. Accordingly, a part of the geospatial data 4400 prepared in advance, which is requested by the application 5000, can be provided from the geospatial data platform 4000 to the application 5000.

Step 10301 indicates a start point of the data request program 4360. The data request program 4360 is started when the application 5000 transmits the geospatial data request to the geospatial data platform 4000. The geospatial data request includes, for example, an application ID and information (scope ID, time stamp, region range, and the like) for specifying a content of the requested geospatial data. These values can be set based on input from an end user, for example, in the application 5000 that requires analysis information regarding a customer asset. Further, in the application 5000 executed periodically or at the time of notification, the value can be set such that an analysis can be performed as soon as new geospatial data is available.

In step 10302, the application that has transmitted the geospatial data request and a content of the request are verified. Here, for example, an application ID and a scope ID in the received geospatial data request are acquired, and a row in which the acquired application ID and scope ID are set in the app 11002 and the scope ID 11001, respectively, is searched in the registered scope table 4320. At this time, the authentication mechanism such as a digital certificate or a digital token may be optionally used for verifying whether the acquired application ID is legitimate. If the corresponding row is not found in the registered scope table 4320, an error is returned to the application 5000 and the data request program 4360 is terminated.

In step 10303, available geospatial data is acquired from the geospatial data 4400. Here, for example, a scope ID in the received geospatial data request is acquired, and rows in which the acquired scope ID is set in the association scope 4401 and the status 4407 is “preparation complete” are searched in the geospatial data 4400. At this time, a list of available geospatial data may be provided to the application 5000.

In step 10304, the geospatial data acquired in step 10303 is subjected to temporal filtering. Here, for example, the temporal filtering is performed by searching for a row in which a value of a time stamp in the received geospatial data request is within a time range indicated by the time slice 4405 among the rows of the geospatial data 4400 found in step 10303. If the corresponding row is not found, an error is returned to the application 5000 and the data request program 4360 is terminated.

In step 10305, the geospatial data that has been subjected to the temporal filtering in step 10304 is further subjected to spatial filtering. Here, for example, the spatial filtering is performed by searching for a row in which a region range in the received geospatial data request is within the geographical range indicated by the region 4403 among the rows of the geospatial data 4400 found in step 10304. If the corresponding row is not found, an error is returned to the application 5000 and the data request program 4360 is terminated.

In step 10306, the geospatial data subjected to the spatial filtering in step 10305 is acquired and provided to the application 5000. Here, for example, the data 4402 is read from the row of the geospatial data 4400 found in step 10305, and is returned to the application 5000 that has transmitted the geospatial data request. At this time, when a value of the region range in the received geospatial data request is smaller than the geographical range indicated by the region 4403, only a data portion corresponding to the region range in the geospatial data request may be extracted from the read data 4402 and transmitted to the application 5000. Furthermore, at this time, values such as the time stamp 4404, the time slice 4405, the predicted date and time 4406, and the association information 4409 can also be returned. If necessary, information necessary for the application 5000 to download geospatial data later, such as FTP connection information, may be transmitted.

After the processing of step 10306 is executed, the data request program 4360 is terminated. Step 10307 indicates an end point of the data request program 4360.

### FIG. 14: Dynamic Area Calculation Process

FIG. 14 is a flowchart illustrating a processing procedure of a dynamic area calculation process. In step 10104 of FIG. 11, the data update unit 4240 performs the dynamic area calculation process according to the processing procedure in FIG. 14. Step 10401 indicates a start point of the dynamic area calculation process.

In step 10402, the type of database to be referred to when the geographical range of the dynamic area is obtained is determined. Here, for example, a value of the reference database 4312 is read from the row of the dynamic area table 4310 specified in step 10104, and the type of the database to be referred to is determined based on the value. As a result, when the value of the reference database 4312 is “LULC”, it is determined that the database to be referred to is the LULC data set 7000, and the process proceeds to step 10403. On the other hand, when the value of the reference database 4312 is the “customer data”, it is determined that the database to be referred to is the customer database 9000, and the process proceeds to step 10404. Further, when the value of the reference database 4312 is the “news distribution”, it is determined that the database to be referred to is the news distribution service 8000, and the process proceeds to step 10405.

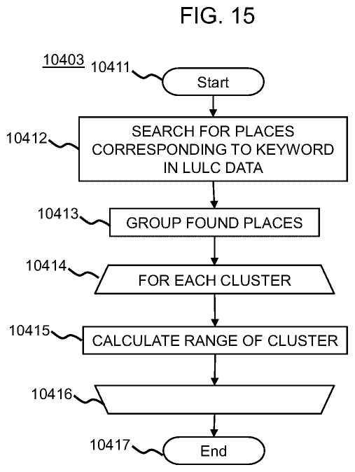

In step 10403, a dynamic area calculation process for the LULC is executed. Here, with reference to the LULC data set 7000, in the LULC data 7100 in the LULC data set 7000, a cell satisfying the region conditions (keyword 4313, keyword search target 4314, association date 4315, association position 4316, and association ID 41317) described in the row of the dynamic area table 4310 specified in step 10104 is specified. Further, a range of the specified cell is set as the geographical range of the dynamic area at the current time. Details of a processing content in step 10403 will be described later with reference to a flowchart shown in FIG. 15.

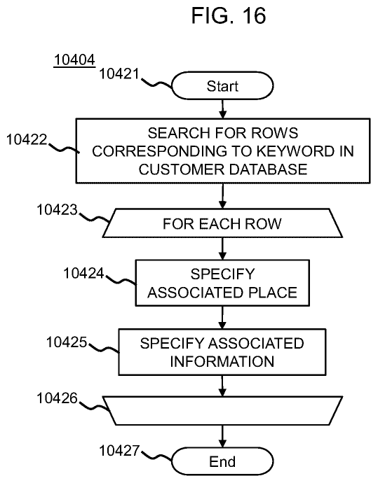

In step 10404, a dynamic area calculation process for the customer data is executed. Here, with reference to the customer database 9000, a row satisfying the region conditions described in the row of the dynamic area table 4310 specified in step 10104 is specified in the customer data 9100 in the customer database 9000. Further, the geographical range of the dynamic area at the current time is calculated based on a description content of the specified row. Details of a processing content in step 10404 will be described later with reference to a flowchart shown in FIG. 16.

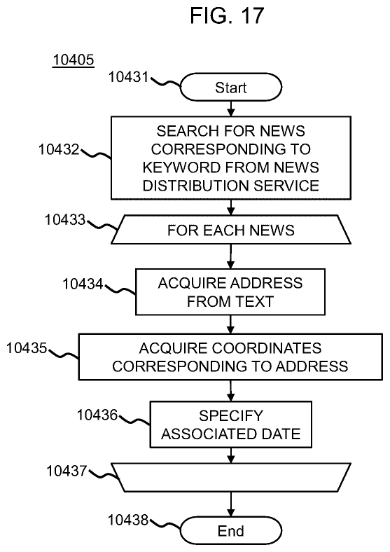

In step 10405, a dynamic area calculation process for the news distribution is executed. Here, with reference to the news distribution service 8000, and a row satisfying the region conditions described in the row of the dynamic area table 4310 specified in step 10104 is specified in the news distribution data 8100 of the news distribution service 8000. Further, the geographical range of the dynamic area at the current time is calculated based on a description content of the specified row. Details of a processing content of step 10405 will be described later with reference to a flowchart shown in FIG. 17.

After the processing of any one of steps 10403, 10404, and 10405 is executed, the dynamic area calculation process ends. Step 10406 indicates an end point of the dynamic area calculation process.

### FIG. 15: Dynamic Area Calculation Process for LULC

FIG. 15 is the flowchart illustrating a processing procedure of the dynamic area calculation process for the LULC. In step 10403 of FIG. 14, the data update unit 4240 performs the dynamic area calculation process according to the processing procedure in FIG. 15. Step 10411 indicates a start point of the dynamic area calculation process for the LULC.

In step 10412, places corresponding to a keyword are searched in the LULC data 7100. Here, for example, values of the keyword 4313 and the keyword search target 4314 are read from the row of the dynamic area table 4310 specified in step 10104. Further, in the LULC data 7100, by searching for cells in which a text represented by the value of the read keyword 4313 is included in the attribute information T designated in the keyword search target 4314, it is possible to search for the places corresponding to the keyword.

In step 10413, the places found in step 10412 are grouped. Here, grouping of the cells is performed by classifying cells adjacent to each other among the plurality of cells found in step 10412 into the same cluster. At this time, for example, a well-known clustering algorithm such as a K-means method may be used.

In step 10414, iterative processing is started for each cluster obtained in step 10413.

In step 10415, a range of a currently processed cluster is calculated. Here, for example, a cluster range is calculated by specifying an outermost cell in the cluster and acquiring a position of the cell. At this time, as an option, a margin of a predetermined size, for example, equivalent to a size of each cell included in the LULC data 7100, may be added to the cluster range. The cluster range calculated here represents geographical range of a dynamic area according to a current situation.

In step 10416, the iterative processing in step 10414 ends. Once the iterative processing has been completed for all the clusters, the dynamic area calculation process for the LULC ends. Step 10417 indicates an end point of the dynamic area calculation process for the LULC.

### FIG. 16: Dynamic Area Calculation Process for Customer Data

FIG. 16 is the flowchart illustrating a processing procedure of the dynamic area calculation process for the customer data. In step 10404 of FIG. 14, the data update unit 4240 performs the dynamic area calculation process according to the processing procedure in FIG. 16. Step 10421 indicates a start point of the dynamic area calculation process for the customer data.

In step 10422, rows corresponding to the keyword is searched in the customer data 9100. Here, for example, values of the keyword 4313 and the keyword search target 4314 are read from the row of the dynamic area table 4310 specified in step 10104. Further, in the customer data 9100, by searching for rows in which a text represented by the value of the read keyword 4313 in a column designated by the keyword search target 4314, the rows corresponding to the keyword are searched. Accordingly, for example, rows including the keyword such as “farmland”, a “power transmission line”, and a “power plant” in the asset type 9102 are searched in the customer data 9100.

In step 10423, iterative processing is started for each row of the customer data 9100 searched in step 10422.

In step 10424, a place associated with the dynamic area is specified. Here, for example, a value of the association position 4316 is read from the row of the dynamic area table 4310 specified in step 10104. Then, in the currently processed row in the customer data 9100, a value of a column corresponding to the value read from the dynamic area table 4310 is read, and a place described therein is specified as the place associated with the dynamic area according to the current situation. Accordingly, for example, each coordinate value stored in the asset place 9103 of the row in the customer data 9100 is acquired as information indicating the place associated with the dynamic area.

In step 10425, information associated with the dynamic area is specified. Here, for example, a value of the association ID 4317 is read from the row of the dynamic area table 4310 specified in step 10104. Then, in the currently processed row in the customer data 9100, a value of a column corresponding to the value read from the dynamic area table 4310 is read, and information described therein is specified as information associated with the dynamic area according to the current situation. Accordingly, for example, an ID number stored in the asset ID 9101 of the row in the customer data 9100 is acquired as the information associated with the dynamic area.

In step 10426, the iterative processing in step 10423 ends. Once the iterative processing is completed for all the rows of the customer data 9100 searched in step 10422, the dynamic area calculation process for the customer data ends. Step 10427 indicates an end point of the dynamic area calculation process for the customer data.

### FIG. 17: Dynamic Area Calculation Process for News Distribution

FIG. 17 is the flowchart illustrating a processing procedure of the dynamic area calculation process for the news distribution. In step 10405 of FIG. 14, the data update unit 4240 performs the dynamic area calculation process according to the processing procedure in FIG. 17. Step 10431 indicates a start point of the dynamic area calculation process for the news distribution.

In step 10432, rows corresponding to the keyword are searched in the news distribution data 8100. Here, for example, values of the keyword 4313 and the keyword search target 4314 are read from the row of the dynamic area table 4310 specified in step 10104. Further, in the news distribution data 8100, by searching for rows in which a text represented by the value of the read keyword 4313 in a column designated by the keyword search target 4314, the rows corresponding to the keyword are searched. Accordingly, for example, a row including the keyword such as “fire” in the news content 8102 is searched in the news distribution data 8100.

In step 10433, iterative processing is started for each row of the news distribution data 8100 searched in step 10432.

In step 10434, in a currently processed row in the news distribution data 8100, a portion representing an address is specified from a text described in the column in which the keyword search is performed in step 10432.

In step 10435, coordinates corresponding to the address specified in step 10434 are acquired. Here, the coordinates corresponding to the address are acquired by transmitting a request for a place corresponding to the address specified in step 10434 to the geocoding service 6000 and receiving information returned from the geocoding service 6000.

In step 10436, a date associated with a dynamic area is specified. Here, for example, a value of the association date 4315 is read from the row of the dynamic area table 4310 specified in step 10104. Further, in the currently processed row in the news distribution data 8100, a value of a column corresponding to the value read from the dynamic area table 4310 is read, and a date described therein is specified as the date associated with the dynamic area according to a current situation. Accordingly, for example, a date stored in the publication date 8101 of the row in the news distribution data 8100 is acquired as the date associated with the dynamic area.

In step 10437, the iterative processing in step 10433 ends. Once the iterative processing is completed for all the rows of the news distribution data 8100 searched in step 10432, the dynamic area calculation process for the news distribution ends. Step 10438 indicates an end point of the dynamic area calculation process for the news distribution.

According to the embodiment of the invention described above, the following effects are obtained.
(1) The geospatial data platform 4000 is a system that acquires the geospatial data 4400 according to the acquisition condition registered in advance by the dynamic area table 4310 and the registered scope table 4320 and provides the acquired geospatial data 4400 to the application 5000. The acquisition condition includes the region conditions (region 11006 and region margin 11007) related to the geographical range of the geospatial data 4400 in the future and the time conditions (reference date 11008, time range 11009, and time resolution 11010) related to the acquisition timing of the geospatial data 4400. For each acquisition timing designated by the time conditions, the geospatial data 4400 satisfying the region conditions at the acquisition timing is prepared before the request from the application 5000 (steps 10111, 10205, and 10207). In this way, it is possible to shorten a response time in the service for the application 5000 that provides the service using the geospatial data to the user.
(2) The region condition represented by the region 11006 includes the condition of the geographical range of the dynamic area which is a dynamically changing region. Further, the geospatial data platform 4000 includes the data update unit 4240 that calculates the geographical range of the dynamic area at the acquisition timing designated by the time condition using information of an external resource. In this way, it is possible to reliably calculate the geographical range of the dynamic area in which the geographical range dynamically changes in accordance with the situation.
(3) The information of the external resource includes the LULC data set 7000. The data update unit 4240 searches for a range of a region satisfying a predetermined condition in the LULC data set 7000 at the acquisition timing designated by the time condition, thereby calculating the geographical range of the dynamic area at the acquisition timing (FIG. 15). In this way, for example, it is possible to appropriately determine a geographical range in which weather forecast data as geospatial data necessary for this service is provided to an application that predicts a risk of forest fire in a domestic forest area using daily weather forecast data.
(4) The information of the external resource includes the customer database 9000 and the geocoding service 6000, which are databases including geographical information. The data update unit 4240 searches for a range of a region satisfying a predetermined condition in the customer database 9000 and the geocoding service 6000 at the acquisition timing designated by the time condition, thereby calculating the geographical range of the dynamic area at the acquisition timing (FIG. 16). In this way, for example, it is possible to appropriately determine a geographical range in which NDVI data as geospatial data necessary for this service is provided to an application that analyzes vegetation by comparing the NDVI data at two past time points for a place of an asset held by a customer and provides an analysis result to the customer.
(5) Further, the information of the external resource includes the news distribution service 8000 which is the database for the news distribution. The data update unit 4240 searches for news including a geographical keyword designated in the news distribution service 8000 at the acquisition timing designated by the time condition, and searches for a range of a region corresponding to the geographical keyword in the found news, thereby calculating the geographical range of the dynamic area at the acquisition timing (FIG. 17). In this way, for example, when a forest fire is reported by news, it is possible to appropriately determine a geographical range in which imaging data as geospatial data necessary for this service is provided to an application that compares two images before and after the forest fire and provides the user with insight into the damage assessment.

The invention is not limited to the embodiment, and it is needless to say that various modifications can be made without departing from the gist of the invention. For example, the embodiment described above is described in detail to facilitate understanding of the invention, and the invention is not necessarily limited to those including all the configurations described above. In addition, another configuration can be added to, deleted from, or replaced with a part of a configuration of each embodiment.

A part or all of the configurations, function units, processing units, processing methods, and the like described above may be implemented, for example, a GPU, or may be implemented by hardware by designing with an FPGA or an integrated circuit. In addition, the configurations, functions, and the like described above may be implemented by software by a processor (including at least a CPU and a GPU) interpreting and executing a program for implementing each function. Information such as a program, a table, and a file for implementing the functions can be stored in a recording device such as a memory, a hard disk, or SSD, or a recording medium such as an IC card, an SD card, and a DVD.

In addition, in each drawing described above, control lines and information lines that are considered necessary for description are shown, and not all the control lines and information lines on implementation are necessarily shown. For example, it may be considered that almost all configurations are actually interconnected.

What is claimed is:

1. A geospatial data platform that is a system that includes one or more processors and one or more communication interfaces, acquires geospatial data corresponding to an acquisition condition registered in advance, and provides the acquired geospatial data to an application via the one or more communication interfaces, wherein
the acquisition condition includes a region condition related to a geographical range of the geospatial data in the future and a time condition related to an acquisition timing of the geospatial data, and
the one or more processors prepare, for each acquisition timing designated by the time condition, the geospatial data satisfying the region condition at the acquisition timing before a request is made from the application.

2. The geospatial data platform according to claim 1, wherein
the region condition includes a condition of a geographical range of a dynamic area which is a dynamically changing region, and
the one or more processors calculate the geographical range of the dynamic area at the acquisition timing using information of an external resource.

3. The geospatial data platform according to claim 2, wherein
the information of the external resource includes a land use and land cover data set, and
the one or more processors calculate, by searching for a range of a region satisfying a predetermined condition in the land use and land cover data set at the acquisition timing, the geographical range of the dynamic area at the acquisition timing.

4. The geospatial data platform according to claim 2, wherein
the information of the external resource includes a database including geographical information, and
the one or more processors calculate, by searching for a range of a region satisfying a predetermined condition in the database at the acquisition timing, the geographical range of the dynamic area at the acquisition timing.

5. The geospatial data platform according to claim 2, wherein
the information of the external resource includes a database for a news distribution, and
the one or more processors calculate, by searching for news including a geographical keyword designated in the database at the acquisition timing and searching for a range of a region corresponding to the geographical keyword in the found news, the geographical range of the dynamic area at the acquisition timing.

6. A geospatial data using system comprising:
the geospatial data platform according to claim 1; and
one or more computers configured to perform processing of at least one of a geospatial data provider, the application, a geocoding service, the LULC data set, a news distribution service, and a customer database.

7. A geospatial data providing method for acquiring geospatial data corresponding to an acquisition condition registered in advance and providing the geospatial data to an application,
the acquisition condition including a region condition related to a geographical range of the geospatial data in the future and a time condition related to an acquisition timing of the geospatial data,
the method comprising:
a computer preparing, for each acquisition timing designated by the time condition, the geospatial data satisfying the region condition at the acquisition timing before a request is made from the application; and
providing the prepared geospatial data from the computer to the application in response to the request from the application.

8. The geospatial data providing method according to claim 7, wherein
the region condition includes a condition of a geographical range of a dynamic area which is a dynamically changing region, and
the method further comprises the computer calculating the geographical range of the dynamic area at the acquisition timing using information of an external resource.

9. The geospatial data providing method according to claim 8, wherein
the information of the external resource includes a land use and land cover data set, and
by searching for a range of a region satisfying a predetermined condition in the land use and land cover data set at the acquisition timing, the geographical range of the dynamic area at the acquisition timing is calculated by the computer.

10. The geospatial data providing method according to claim 8, wherein
the information of the external resource includes a database including geographical information, and
by searching for a range of a region satisfying a predetermined condition in the database at the acquisition timing, the geographical range of the dynamic area at the acquisition timing is calculated by the computer.

11. The geospatial data providing method according to claim 8, wherein
the information of the external resource includes a database for a news distribution, and
by searching for news including a geographical keyword designated in the database at the acquisition timing and searching for a range of a region corresponding to the geographical keyword in the found news, the geographical range of the dynamic area at the acquisition timing is calculated by the computer.

12. A program causing the computer to execute the geospatial data providing method according to claim 7.
